(19) United States
(12) Patent Application Publication
(10) Pub. No.: US 2009/0319184 A1
(43) Pub. Date: Dec. 24, 2009

(54) GUIDANCE SYSTEM

(75) Inventors: Kentaro Teshima, Kariya-city (JP); Kazuhiro Nakashima, Kariya-city (JP); Toshio Shimomura, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/485,374

(22) Filed: Jun. 16, 2009

(30) Foreign Application Priority Data
Jun. 18, 2008 (JP) 2008-159579

(51) Int. Cl. G01C 21/00

(52) U.S. Cl. 701/211

(57) ABSTRACT

A guidance system includes: a device having a first human body communication unit for performing human body communication via a human body; a switch having a second human body communication unit for performing human body communication via the human body; and a controller controlling the device and the switch. The controller obtains device information relating to the device from the first human body communication unit via the human body and the second human body communication unit when the human body contacts both of the first and second human body communication units. The controller provides guidance corresponding to the device information.

### CROSS REFERENCE TO RELATED APPLICATION

This application is based on Japanese Patent Application No. 2008-159579 filed on Jun. 18, 2008, the disclosure of which is incorporated herein by reference.

### FIELD OF THE INVENTION

The present invention relates to a guidance system for guiding an operation method of a predetermined device.

### BACKGROUND OF THE INVENTION

Conventionally, a technique for displaying an manual for operating an in-vehicle device and a vehicle itself is well known. For example, JP-A-2002-160588 teaches a technique for displaying an electric manual for a vehicle on a display and for selecting vehicle information shown on the display. Specifically, the vehicle information relates to information about a part of the vehicle, a state of the part of the vehicle and an operation method of the part of the vehicle.

However, when a user requests the vehicle information about a certain part of the vehicle, it is necessary for the user to select the vehicle information on the display. Thus, the user has to operate the display, so that it requires additional task.

### SUMMARY OF THE INVENTION

In view of the above-described problem, it is an object of the present disclosure to provide a guidance system for guidance of a predetermined device.

According to a first aspect of the present disclosure, a guidance system includes: a device having a first human body communication unit for performing human body communication via a human body; a switch having a second human body communication unit for performing human body communication via the human body; and a controller controlling the device and the switch. The controller obtains device information relating to the device from the first human body communication unit via the human body and the second human body communication unit when the human body contacts both of the first and second human body communication units. The controller provides guidance corresponding to the device information. In this case, the guidance about the device is easily and intuitively performed.

According to a second aspect of the present disclosure, a guidance system includes: a display for displaying an image of a device; a touch switch integrated in the display; a first human body communication unit arranged in the display and performing human body communication via a human body and the touch switch; a guidance switch having a second human body communication unit for performing human body communication via the human body; and a controller. The controller obtains device information relating to the device from the first human body communication unit via the touch switch, the human body and the second human body communication unit when the human body contacts the first human body communication unit via the touch switch and further contacts the second human body communication unit, and the controller provides guidance corresponding to the device information. In this case, the guidance about the device is easily and intuitively performed.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram showing a guidance system according to an example embodiment;

FIG. 2 is a block diagram showing a guidance controller in the system; and

FIG. 3 is a diagram showing a guidance system according to another example embodiment.

### DETAILED DESCRIPTION OF THE PREFERRED EMBODIMENTS

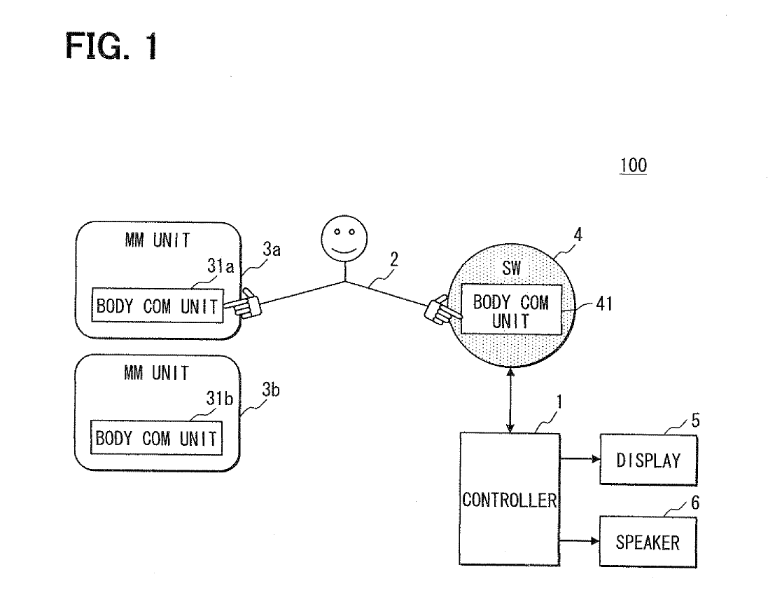

FIG. 1 shows a guidance system 100. The system 100 includes a guidance controller 1, module mounting units 3a, 3b having a human body communication module, a help switch 4, a display 5 for guidance and a speaker 6 for guidance. The controller 1, the module mounting units 3a, 3b, the switch 4, the display 5 and the speaker 6 are mounted on or arranged in a vehicle.

A user 2 is an occupant of the vehicle. The first module mounting unit 3a includes a human body communication unit 31a, and is mounted on the vehicle. The second module mounting unit 3b includes a human body communication unit 31b, and is mounted on the vehicle. Each module mounting unit 3a, 3b includes the human body communication unit 31a, 31b. For example, the module mounting unit 3a, 3b is an in-vehicle navigation device, an ETC (electronic toll collection system) device, a vehicle air conditioner, a vehicle audio system or the like.

The human body communication unit 31a, 31b transmits the vehicle information to the human body communication unit 41 in the switch 4 via the user 2. The human body communication unit 31a, 31b includes a device information obtaining unit, a human body communication module and a communication terminal. Here, the human body communication is communication with using a human body as a transmission path. The human body communication is disclosed in; for example, JP-H10-228524 corresponding to U.S. Pat. No. 5,796,827. In this embodiment, the human body communication is performed by an electric field type human body communication. Alternatively, the communication may be performed by a current type human body communication.

The device information obtaining unit obtains the device information when a request signal is received by the human body communication module, and transmits the device information to the human body communication module. Here, the device information relates to the module mounting unit 3a, 3b. For example, the device information includes a unit ID as an identifier for identifying the module mounting unit 3a, 3b, operation history information for showing operation record of an individual person as the user operating the module mounting unit 3a, 3b, a trouble code for showing a state of the module mounting unit 3a, 3b, and the like. The device information obtaining unit in the human body communication unit 31a obtains the device information of the first module mounting unit 3a, and the device information obtaining unit in the human body communication unit 31b obtains the device information of the second module mounting unit 3b.

The human body communication module is a well-known communication module for the human body communication. The human body communication module receives the request signal from the help switch 4 via the user 2 and the communication terminal. Here, the user 2 contacts the help switch 4. Specifically, the user 2 contacts the communication electrode in the human communication unit 41 via an insulator. The request signal represents a signal for requesting transmission of the device information. The request signal is output from the help switch 4. The user 2 further contacts the communication terminal in the human body communication unit 31a via an insulator. The human body communication module transmits the device information from the device information obtaining unit in the human body communication unit 31a to the human communication unit 41 in the help switch 4 via the user 2 when the human body communication module receives the request signal. The user 2 contacts the communication terminal of the human body communication unit 31a via the insulator.

The communication terminal is a well known terminal for the human body communication. The communication terminal is disposed in the module mounting unit 3a, 3b such that the user 2 can touch the communication terminal via the insulator. Specifically, a casing of the module mounting unit 3a, 3b has a part, which is exposed in a compartment of the vehicle. The communication terminal including the insulator is exposed on the part of the casing.

The help switch 4 includes the human body communication unit 41 and is arranged in the vehicle. For example, the switch 4 has a part, which is exposed in the compartment of the vehicle. Further, the switch 4 is arranged on an instrumental panel. Alternatively, the switch 4 may be arranged on another part of the vehicle as long as the part of the switch 4 is exposed in the compartment. For example, the switch 4 may be arranged on a steering wheel column.

The human body communication unit 41 receives the device information transmitted from the module mounting unit 3a, 3b via the user 2 so that the human body communication is performed. The human body communication unit 41 includes a human body communication module and a communication terminal.

The human body communication module in the help switch 4 is a well known communication module for the human body communication. When the human body communication between the switch 4 and the module mounting unit 3a, 3b is established, the request signal for requiring the device information is transmitted to one of the first and second module mounting units 3a, 3b, which contacts the user 2, via the user 2 contacting the communication terminal of the switch 4 via the insulator Further, the human body communication module in the switch 4 receives the device information transmitted from the one of the first and second module mounting units 3a, 3b, which contacts the user 2, via the communication terminal in the switch 4 and the user 2 contacting the communication terminal of the switch 4 via the insulator. Here, the one of the first and second module mounting units 3a, 3b includes the communication terminal in the human body communication unit 31a, 31b, which contacts the user 2 via the insulator. The human body communication module in the switch 4 transmits the device information to the guidance controller 1.

The communication terminal in the switch 4 is a well known electrode for the human body communication. The communication terminal in the switch 4 is arranged in the help switch 4 such that the user 2 can touch the communication terminal via the insulator. Specifically, the communication terminal together with the insulator is exposed on the part of the casing of the switch 4, which is exposed in the compartment of the vehicle.

The guidance controller 1 obtains the device information, which is transmitted from the human body communication module in the switch 4. The controller 1 provides to guide the information about the one of the first and second module mounting units 3a, 3b according to the device information. Specifically, the controller 1 controls the display 5 and the speaker 6 to output the device information. For example, the controller 1 is arranged on the inside of the instrument panel of the vehicle. Alternatively, the controller 1 may be arranged on another part of the vehicle.

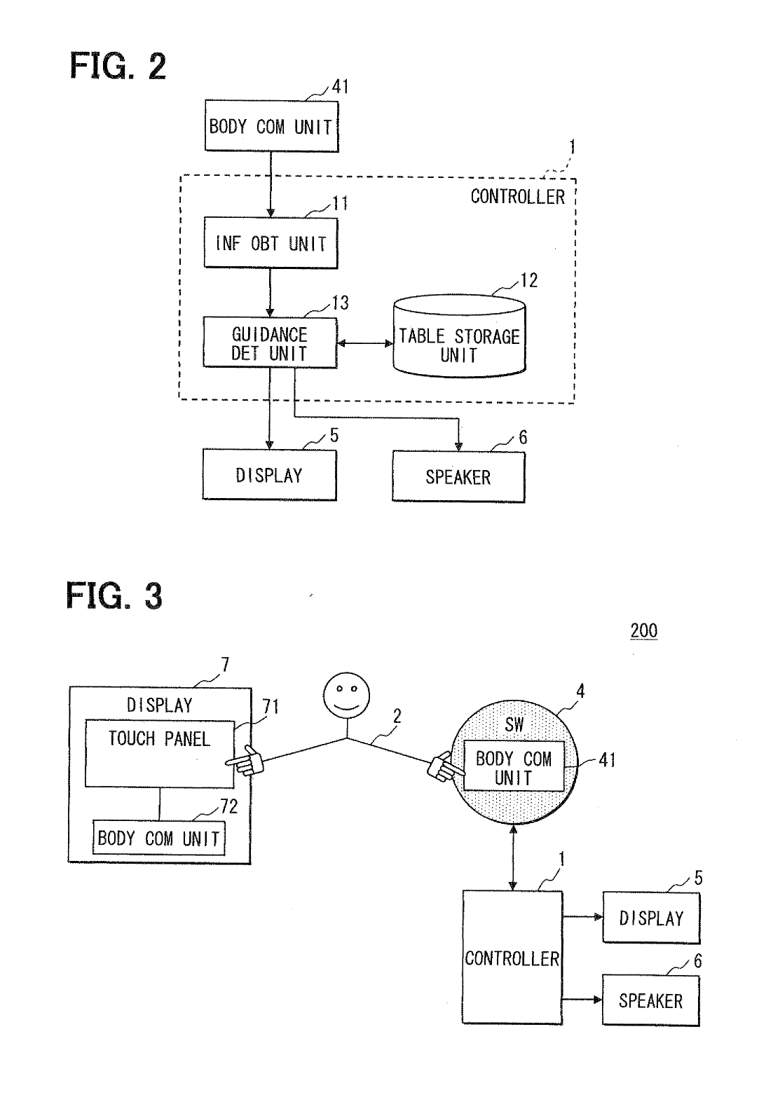

As shown in FIG. 2, the guidance controller 1 includes a device information obtaining unit 11, a table storage unit 12 and a guidance determination unit 13. The controller 1 is formed of a conventional computer. The controller 1 includes a CPU, a ROM, a RAM, an I/O unit and a bus line, which connects among the CPU, the ROM, the RAM and the I/O unit.

The device information obtaining unit 11 in the controller 1 obtains the device information transmitted from the human body communication module in the switch 4, and outputs the information to the guidance determination unit 13.

The table storage unit 12 is a memory for preliminarily storing the device information and data of the guidance corresponding to the device information. For example, the table storage unit 12 stores a correspondence relationship table for showing a relationship between the device information and the data of the guidance corresponding to the device information. In the storage unit 12, the data of the guidance for an operating method of the device corresponding to the unit ID is preliminarily related to the unit ID. Further, the data of the guidance for troubleshooting corresponding to trouble shown as a trouble code is preliminarily related to the trouble code. Further, the data of the guidance for troubleshooting corresponding to trouble estimated from the operation history information is preliminarily related to the operation history information. The data of the guidance includes data of an image, data of a text, and data of sound or voice message. The guidance of the troubleshooting corresponding to trouble estimated from the operation history information may include guidance of a proper operation method with respect to the improper operation of the user, which is estimated from the operation history information.

The guidance determination unit 13 refers to the correspondence relationship table in the table storage unit 12 based on the device information transmitted from the device information obtaining unit 11 in the controller 1, so that the guidance determination unit 13 obtains the data of the guidance corresponding to the device information. For example, when the device information transmitted from the device information obtaining unit 11 is the unit ID, the guidance determination unit 13 obtains the data of the guidance regarding to the operation method corresponding to the unit ID by referring to the table. When the device information transmitted from the device information obtaining unit 11 is a trouble code, the guidance determination unit 13 obtains the data of the guidance regarding to the troubleshooting corresponding to the trouble code by referring to the table. When the device information transmitted from the device information obtaining unit 11 is the operation history information, the guidance determination unit 13 obtains the data of the guidance regarding to the troubleshooting corresponding to the operation history information by referring to the table. The guidance determination unit 13 sends the obtained guidance data to the display 5 for guidance and the speaker 6 for guidance. Specifically, when the guidance data includes the image data and/or the text data, the image data and/or the text data are sent from the guidance determination unit 13 to the display 5. When the guidance data includes the voice and/or sound data, the voice and/or sound data is sent from the guidance determination unit 13 to the speaker 6.

In the above process, when the device information transmitted from the device information obtaining unit 11 is the unit ID, the guidance determination unit 13 obtains the data of the guidance regarding to the operation method corresponding to the unit ID by referring to the table. Alternatively, for example, when the device information transmitted from the device information obtaining unit 11 is the trouble code and/or the operation history information in addition to the unit ID, the guidance determination unit 13 may obtain the guidance data regarding to the troubleshooting corresponding to the trouble code and/or the operation history information. In this case, the guidance determination unit 13 specifies the device based on the unit ID.

The display 5 for guidance displays the guidance image and/or the guidance text according to the guidance data transmitted from the guidance determination unit 13. The display is, for example, a full color display unit such as a liquid crystal display, an organic EL display, a plasma display or the like. The display may be the same as the display in the in-vehicle navigation device.

The speaker 6 outputs the guidance voice message and/or the guidance sound according to the guidance data transmitted from the guidance determination unit 13.

The guidance system 100 performs guidance according to the following process. Here, for example, the user 2 obtains the guidance regarding to the operation method of the module mounting unit 3a.

First, the user 2 touches both of the human body communication unit 31a in the module mounting unit 3a and the human body communication unit 41 in the switch 4. Specifically, the user 2 touches both of the communication terminal in the human body communication unit 31aand the communication electrode in the human communication unit 41. Thus, the unit ID is transmitted from the human body communication unit 31a in the module mounting unit 3a to the human body communication unit 41 in the switch 4 via the communication terminal in the human body communication unit 31a, the user 2 and the communication electrode in the human communication unit 41. The unit ID received by the human body communication unit 41 in the switch 4 is sent to the guidance controller 1 by the human body communication module in the human communication unit 41.

The controller 1 obtains the guidance data of the operation method corresponding to the unit ID based on the unit ID transmitted from the communication module in the human communication unit 41. The controller 1 transmits the guidance data of the operation method to the display 5 and/or the speaker 6 so that the display 5 displays the guidance image and/or the speaker 6 outputs the guidance sound according to the guidance data of the operation method.

When the user 2 obtains the guidance regarding the operation method of the module mounting unit 3b, the user 2 touches both of the communication terminal in the human body communication unit 31b of the module mounting unit 3b and the communication electrode in human body communication unit 41 of the switch 4.

Thus, by only touching both of the human body communication unit 31a in the module mounting unit 3a and the human body communication unit 41 in the switch 4, i.e., by only touching the switch 4 and the module mounting unit 3a, which is an object device for guidance, the user 2 obtains the guidance regarding the operation method and/or the troubleshooting in the object device for guidance that is the module mounting unit 3a. Thus, the user 2 merely touches the switch 4 and the object device for guidance such as the operation method guidance and/or the troubleshooting guidance, so that the user 2 obtains the guidance of the object device. The guidance for the object device is performed intuitively for the user 2.

The guidance system 100 includes two devices such as the first and second module mounting units 3a, 3b having the human body communication units 31a, 31b. Alternatively, the guidance system 100 may include only one device having a module mounting unit. Further, the guidance system 100 may include three or more devices having a module mounting unit.

The user 2 directly touches the object device for guidance so that the user 2 obtains the guidance of the object device. Alternatively, the user 2 may directly touch an image showing the object device for guidance so that the user 2 obtains the guidance of the object device. The guidance system 200 performing this feature will be explained as follows.

FIG. 3 shows the system 200. The system 200 includes the controller 1, the witch 4, the display 5, the speaker 6 and a touch panel display 7, which are mounted on or arranged on a vehicle. The system 200 includes the display 7 instead of the first and second module mounting units 3a, 3b.

The touch panel display 7 includes a touch panel 71 and a human body communication unit 72. The touch panel display 7 displays a device image on a screen of the touch panel 71. The device image represents various devices mounted on or arranged on the vehicle. For example, the device image corresponds to an in-vehicle navigation device, an in-vehicle electronic toll collection device, an air conditioner, a car audio device, an engine, a battery, a head light, a back light and the like. The touch panel display 7 functions as a display. The display 7 may display one device image on the screen of the touch panel 71. Alternatively, the display 7 may display multiple device images on different parts of the screen in the touch panel 71. Further, the display 7 may display multiple device images on the screen of the touch panel 71 one by one.

When the user 2 touches the device image on the screen of the panel 71, the display 7 specifies which device image is touched. Thus, when the user 2 selects one device image, the display 7 sends the information regarding the selected device image to the human body communication unit 72. Here, the information regarding the selected device image is defined as device selection information.

The touch panel 71 is a well known touch panel including a display monitor and a matrix switch, which are integrated. The touch panel 71 is integrated with the display 7. The touch panel 71 functions as a touch switch.

The human body communication unit 72 transmits device information to the human body communication unit 41 in the switch 4 via the touch panel 71 and the user 2 with human body communication. The human body communication unit 72 includes a device information obtaining unit, a human body communication module and a communication terminal. The device information relates to various devices For example, the device information includes the unit ID as an identifier for identifying the device, a trouble code for showing a state of the device, operation history information for showing operation record of an individual person as the user operating the device, and the like.

The device information obtaining unit obtains the device information corresponding to the device image selected by the user 2 according to the device selection information transmitted from the touch panel display 7. The device information may relate to the device itself. Alternatively, the device information may relate to an ECU for controlling the device. The device information obtaining unit transmits the device information to the human body communication module in the display 7.

The human body communication module in the display 7 is a well known communication module for human body communication. A request signal for requesting the device information is transmitted from the switch 4, which contacts the user 2. Specifically, the user 2 touches the communication terminal of the human body communication unit 41 in the switch 4 via an insulator. The human body communication module in the display 7 receives the request signal via the communication terminal in the display 7 and the user 2 who touches the communication terminal in the display 7 via an insulator and the touch panel 71. When the human body communication module in the display 7 receives the request signal, the human body communication module in the display 7 transmits the device information transmitted from the device information obtaining unit in the display 7 to the human body communication unit 41 in the switch 4 contacting the user 2 via the user 2 who touches the communication terminal in the display 7 via the insulator and the touch panel 71.

The communication terminal in the display 7 is a well known communication electrode for using human body communication. The communication terminal is arranged on the touch panel 71 in the display 7 such that the user 2 can touch the communication terminal via the insulator.

The operation of the guidance system 200 will be explained as follows. For example, the user 2 wants to obtain the guidance for troubleshooting with regard to the trouble in the engine of the vehicle. Further, the device image includes an engine image, so that the engine image is displayed on a screen of the display 7, i.e., on a screen of a display monitor of the touch panel 71.

The user 2 touches the engine image among multiple device images on the screen of the display monitor of the touch panel 71. Specifically, the user 2 touches a region of the touch panel 71 corresponding to the engine image. In addition, the user 2 further touches the human body communication unit 41 in the switch 4. Specifically, the user 2 further touches the communication terminal of the human body communication unit 41. Thus, the trouble code showing the state of the engine is transmitted from the human body communication unit 72 in the display 7 to the human body communication unit 41 in the switch 4 via the touch panel 71, the communication terminal in the display 7, the user 2, the communication terminal in the switch 4. The trouble code received by the human body communication unit 41 in the switch 4 is sent to the controller 1 with using the communication module in the switch 4.

Then, the controller 1 obtains the guidance data regarding the troubleshooting corresponding to the trouble code according to the trouble code transmitted from the human body communication module in the switch 4. The controller 1 sends the guidance data regarding the troubleshooting to the display 5 and/or the speaker 6 so that the display 5 and/or the speaker 6 provide guidance according to the guidance data.

Thus, when the user 2 touches the device image region shown on the touch panel 71 in the display 7 and the human body communication unit 41 in the switch 4, the user 2 obtains the guidance about the troubleshooting and/or the operation method of the device. The device image region corresponds to the guidance regarding the troubleshooting and/or the operation method. The guidance about the device is easily and intuitively performed.

In the embodiment, the touch panel display 7 includes one human body communication unit 72, which handles multiple device information. Alternatively, touch panel display 7 may include multiple human body communication units 72, each of which handles one device information.

The touch panel display 7 may be the same as a display in the in-vehicle navigation device having touch panel function.

In the system 100, after the request signal is received, the device information is transmitted. Thus, bidirectional communication is performed. Alternatively, the system 100 may provide single-directional communication. For example, when the system 100 provides the single-directional communication, without sending the request signal from the communication module in the switch 4, the communication module in the module mounting unit 3a, 3b may send the device information periodically. Further, in the system 200, the communication module in the display 7 may send the device information periodically.

The human body communication is performed by the electric field type communication. Alternatively, the human body communication may be performed by the current type communication. In this case, the communication terminal in the module mounting unit 3a, 3b, the communication terminal in the switch 4, and the communication terminal in the display 7 directly contact the user without the insulator.

In the controller 1, the correspondence relationship table in the table storage unit 12 is referred according to the device information, so that the guidance data corresponding to the device information is obtained. Alternatively, for example, the guidance data is received by the human body communication unit 41 in the switch 4 with the human body communication method. The controller 1 controls the display 5 and/or the speaker 6 to provide guidance according to the guidance data received by the human body communication unit 41. In this case, it is not necessary for the controller 1 to include the table storage unit 12 and the guidance determination unit 13.

In the above embodiment, the guidance regarding the device mounted on or arranged on the vehicle is performed. Alternatively, for example, the guidance regarding a device disposed in a house or a facility may be performed. In this case, the device in the house or the facility has the same function as the module mounting units 3a, 3b and the touch panel display 7. The user 2 brings a mobile device including the controller 1, the switch 4, the display 5 and the speaker 6. The user 2 touches both of the device in the house or the facility and the switch 4 so that the guidance regarding the device in the house or the facility is obtained.

The above disclosure has the following aspects.

According to a first aspect of the present disclosure, a guidance system includes: a device having a first human body communication unit for performing human body communication via a human body; a switch having a second human body communication unit for performing human body communication via the human body; and a controller controlling the device and the switch. The controller obtains device information relating to the device from the first human body communication unit via the human body and the second human body communication unit when the human body contacts both of the first and second human body communication units. The controller provides guidance corresponding to the device information. In this case, the guidance about the device is easily and intuitively performed.

Alternatively, the device may include a plurality of elements, each of which includes the first human body communication unit. The controller obtains device information relating to one of the elements from one of the first human body communication units via the human body and the second human body communication unit when the human body contacts both of the second human body communication unit and the one of the first human body communication units in the one of the elements, and the controller provides guidance corresponding to the device information relating to the one of the elements. Alternatively, the controller may include a memory for storing the device information and guidance data corresponding to the device information. The controller obtains the guidance data from the memory when the controller obtains the device information, and the controller provides the guidance based on the guidance data corresponding to the device information. Alternatively, the device information may include information about an identifier for specifying the device, and the controller provides the guidance about an operation method of the device corresponding to the identifier based on the information about the identifier. Alternatively, the device information may include information about a state of the device, and the controller provides the guidance about troubleshooting of the device corresponding to the state of the device based on the information about the state. Alternatively, the system may further include a display; and a speaker. The system is mounted on a vehicle. The device is a navigation device, a ETC device, an air conditioner, or an audio device. The controller controls the display to show an image or a text for guidance, and controls the speaker to output a voice message or a sound for guidance so that the controller provides the guidance.

According to a second aspect of the present disclosure, a guidance system includes: a display for displaying an image of a device; a touch switch integrated in the display; a first human body communication unit arranged in the display and performing human body communication via a human body and the touch switch; a guidance switch having a second human body communication unit for performing human body communication via the human body; and a controller. The controller obtains device information relating to the device from the first human body communication unit via the touch switch, the human body and the second human body communication unit when the human body contacts the first human body communication unit via the touch switch and further contacts the second human body communication unit, and the controller provides guidance corresponding to the device information. In this case, the guidance about the device is easily and intuitively performed.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A guidance system comprising:
a device having a first human body communication unit for performing human body communication via a human body;
a switch having a second human body communication unit for performing human body communication via the human body; and
a controller controlling the device and the switch, wherein
the controller obtains device information relating to the device from the first human body communication unit via the human body and the second human body communication unit when the human body contacts both of the first and second human body communication units, and
the controller provides guidance corresponding to the device information.

2. The system according to claim 1, wherein
the device includes a plurality of elements, each of which includes the first human body communication unit,
the controller obtains device information relating to one of the elements from one of the first human body communication units via the human body and the second human body communication unit when the human body contacts both of the second human body communication unit and the one of the first human body communication units in the one of the elements, and
the controller provides guidance corresponding to the device information relating to the one of the elements.

3. The system according to claim 1, wherein
the controller includes a memory for storing the device information and guidance data corresponding to the device information,
the controller obtains the guidance data from the memory when the controller obtains the device information, and
the controller provides the guidance based on the guidance data corresponding to the device information.

4. The system according to claim 1, wherein
the device information includes information about an identifier for specifying the device, and
the controller provides the guidance about an operation method of the device corresponding to the identifier based on the information about the identifier.

5. The system according to claim 1, wherein
the device information includes information about a state of the device, and
the controller provides the guidance about troubleshooting of the device corresponding to the state of the device based on the information about the state.

6. The system according to claim 1, further comprising:
a display; and
a speaker, wherein
the system is mounted on a vehicle,
the device is a navigation device, a ETC device, an air conditioner, or an audio device, and
the controller controls the display to show an image or a text for guidance, and controls the speaker to output a voice message or a sound for guidance so that the controller provides the guidance.

7. A guidance system comprising:
a display for displaying an image of a device;
a touch switch integrated in the display;
a first human body communication unit arranged in the display and performing human body communication via a human body and the touch switch;
a guidance switch having a second human body communication unit for performing human body communication via the human body; and
a controller, wherein
the controller obtains device information relating to the device from the first human body communication unit via the touch switch, the human body and the second human body communication unit when the human body contacts the first human body communication unit via the touch switch and further contacts the second human body communication unit, and
the controller provides guidance corresponding to the device information.

8. The system according to claim 7, further comprising:
a display; and
a speaker, wherein
the system is mounted on a vehicle,
the device is a navigation device, a ETC device, an air conditioner, or an audio device, and
the controller controls the display to show an image or a text for guidance, and controls the speaker to output a voice message or a sound for guidance so that the controller provides the guidance.
